(19) United States
(12) Patent Application Publication
(10) Pub. No.: US 2011/0318080 A1
(43) Pub. Date: Dec. 29, 2011

(54) PRINTER AND METHOD FOR DRIVING THE SAME

(75) Inventors: Yuichiro Hatanaka, Shizuoka (JP); Toshiyuki Tamura, Shizuoka (JP); Yozo Kobayashi, Shizuoka (JP)

(73) Assignee: TOSHIBA TEC KABUSHIKI KAISHA, Tokyo (JP)

(21) Appl. No.: 13/027,534

(22) Filed: Feb. 15, 2011

(30) Foreign Application Priority Data
Jun. 29, 2010 (JP) 2010-148141

(51) Int. Cl. B41J 11/42

(52) U.S. Cl. 400/582

(57) ABSTRACT

According to one embodiment, a printer includes a holder, a conveyor, a print head, and a conveyance controller. The holder is configured to hold a printing medium wound in a roll, the printing medium having an adhesive surface and a printing surface. The conveyor is configured to release a free end of the printing medium from the roll held by the holder to convey the printing medium. The print head is configured to print information on the printing surface of the printing medium when the printing medium is conveyed by the conveyor. The conveyance controller is configured to control the conveyance speed of the printing medium conveyed by the conveyor such that the printing medium is conveyed at a first acceleration from rest for a predetermined period of time and then a second acceleration to reach a target conveyance speed, wherein the first acceleration is less than the second acceleration.

### CROSS-REFERENCE TO RELATED APPLICATIONS

This application is based upon and claims the benefit of priority from Japanese Patent Application No. 2010-148141, filed on Jun. 29, 2010, the entire contents of which are incorporated herein by reference.

### TECHNICAL FIELD

Embodiments described herein relate to a printer and a method for driving the printer.

### BACKGROUND

In the related art, there is known a label printer for printing information on a liner-less label without a backing sheet.

In the label printer, a liner-less label having an adhesive surface and a printing surface is wound into a paper roll, which is rotatably held by a holder. In conveying the liner-less label, a platen roller is rotationally driven to pull the free end of the liner-less label from the paper roll held by the holder. During this conveying process, a print head prints information on the printing surface of the liner-less label.

The conventional label printer mentioned above is normally kept in a state where the free end of the liner-less label is pulled out from the paper roll by a predetermined length. Therefore, if the label printer is left in a non-use state for a long time, the adhesiveness of the liner-less label at the release point from the paper roll tends to become greater than the adhesiveness of the liner-less label at the release point from the paper roll during a continuous printing state (e.g., during a normal printing operation).

Due to the increased adhesiveness at the release point of the liner-less label from the roll when the label printer is left in a non-use state for a long time, the label printer may fail to properly convey the liner-less label when resuming a printing operation, and thus the printing accuracy may deteriorate at the start of the printing operation.

### BRIEF DESCRIPTION OF THE DRAWINGS

FIG. 1 is a perspective view of a label printer according to one embodiment.

FIG. 2 is a side sectional view showing a schematic configuration of a print unit in the label printer and a conveying state of a liner-less label in the print unit.

FIG. 3 is a block diagram showing a hardware configuration provided within a body housing of the label printer.

FIG. 4 is a block diagram showing a functional configuration of a print control unit of the label printer.

FIG. 5 is a table illustrating conveyance speeds set by a conveyance speed setting unit.

FIGS. 6A, 6B and 6C are graphs depicting conveyance speeds set by the conveyance speed setting unit.

FIG. 7 is a flowchart showing a conveyance control process performed by a print control unit.

FIG. 8 is a side sectional view illustrating one example of a release point in a label printer.

FIG. 9 is a side sectional view illustrating one example of a release point in a label printer in the related art.

### DETAILED DESCRIPTION

According to one embodiment, a printer includes a holder, a conveyor, a print head, and a conveyance controller. The holder is configured to hold a printing medium wound in a roll, the printing medium having an adhesive surface and a printing surface. The conveyor is configured to release a free end of the printing medium from the roll held by the holder to convey the printing medium. The print head is configured to print information on the printing surface of the printing medium when the printing medium is conveyed by the conveyor. The conveyance controller is configured to control the conveyance speed of the printing medium conveyed by the conveyor such that the printing medium is conveyed at a first acceleration from rest for a predetermined period of time and then a second acceleration to reach a target conveyance speed, wherein the first acceleration is less than the second acceleration.

Embodiments will now be described in detail with reference to the accompanying drawings.

A printer according to one embodiment described below is a label printer that may be installed in a backyard or other places of a commodity-selling store and may be used to print a label with information on a commodity such as food.

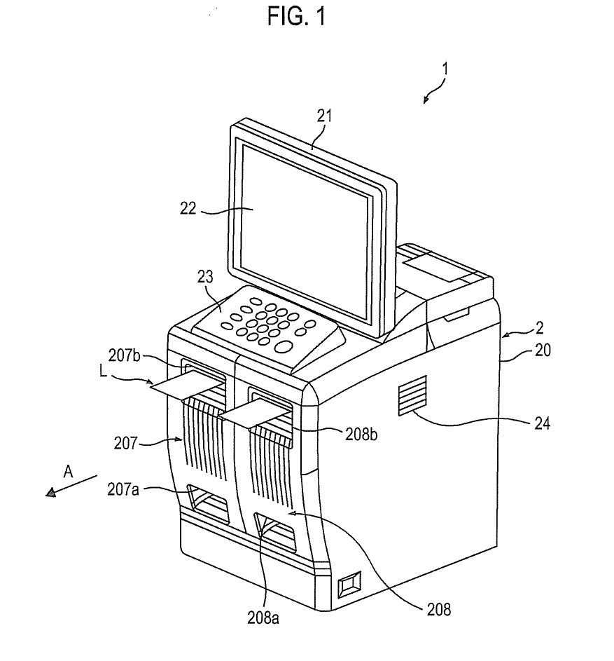

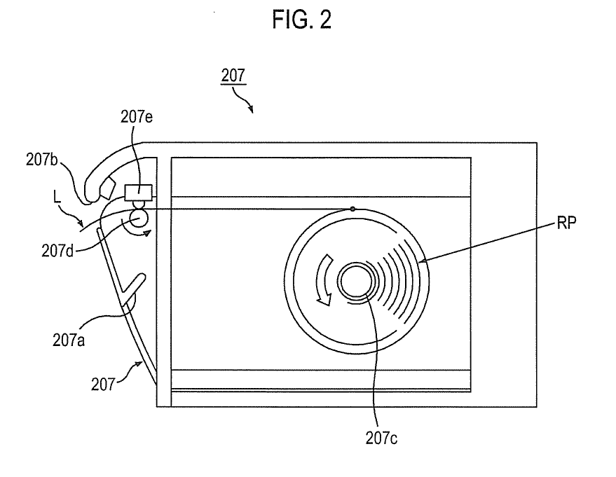

FIG. 1 is a perspective view of a label printer according to one embodiment. FIG. 2 is a side sectional view illustrating a schematic configuration of a print unit in the label printer shown in FIG. 1 and a conveying state of a liner-less label in the label printer.

As shown in FIG. 1, the label printer 1 includes a printing device 2 for printing a liner-less label L with information on a commodity such as a commodity name, price, weight, barcode, etc. The printing device 2 may be electrically connected to a weighing instrument (not shown).

On the upper surface of a body housing 20, the printing device 2 includes a display 21 for displaying the information to be printed on the liner-less label L, a touch panel 22 laminated on the display surface of the display 21 to detect information on touch positions by an operation on the touch panel 22, and a keyboard 23 operated by an operator.

On a side surface of the body housing 20, the printing device 2 includes a sensor window 24 through which a sensor (e.g., a temperature sensor) detects the environmental conditions around the label printer 1.

In the label printer 1 of the present embodiment, two print units, e.g., first and second print units 207 and 208, may be arranged side by side within the body housing 20. The first and second print units 207 and 208 can be removed from the body housing 20 by hooking a finger into groove portions 207a and 208a formed on front lower areas of the print units 207 and 208, respectively, and pulling the print units 207 and 208 in a direction indicated by an arrow A. In front upper areas, the print units 207 and 208 include label dispensing outlets 207b and 208b, respectively, to discharge the label L printed with information.

Since the first and second print units 207 and 208 have the same configuration, only the configuration of the first print unit 207 will be described below.

As shown in FIG. 2, the first print unit 207 includes a holding shaft (or a holder) 207c, a platen roller (a conveyor) 207d, and a thermal head (a print head) 207e.

The holding shaft 207c rotatably holds a paper roll (a heat-sensitive paper roll) RP produced by winding an elongated liner-less label (printing medium) L without a backing sheet (liner) in a roll shape. The liner-less label L has a front printing surface (heat-sensitive coloring layer) and a rear adhesive surface (adhesive layer).

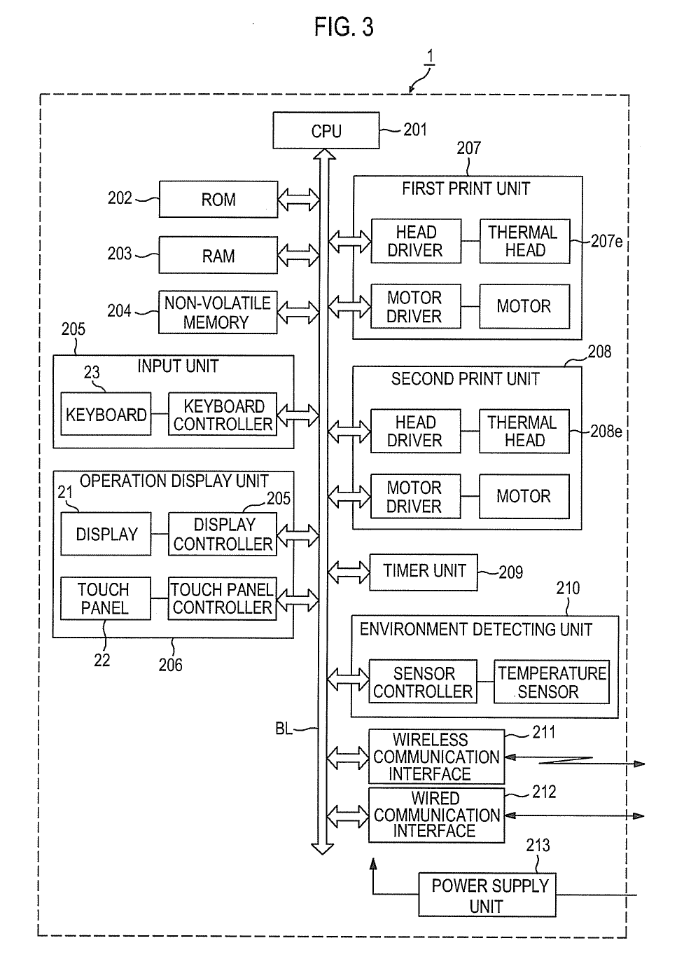

The platen roller 207d is rotationally driven by a motor (see FIG. 3) to discharge the free end of the liner-less label L from the paper roll RP held by the holding shaft 207c and to convey the same toward the label dispensing outlet 207b (in the conveying direction).

The thermal head 207e prints information on the printing surface of the liner-less label L. The platen roller 207d is provided at a position opposite the thermal head 207e with the liner-less label L interposed therebetween.

The label printer 1 configured as above may be in a stand-by state (e.g., a non-use state shown in FIG. 2 in which the printer 1 is not printing) in which the liner-less label L is not discharged from the label dispensing outlet 207b and the paper roll RP and the liner-less label L remain in specified set positions. In the stand-by state, when an operator enters printing information and inputs an instruction to print a label (e.g., a label issuing instruction) to the label printer 1, the platen roller 207d is rotationally driven to pull the liner-less label L from the paper roll RP held by the holding shaft 207c and convey the liner-less label L toward the label dispensing outlet 207b. In this conveying process, the thermal head 207e prints information on the printing surface of the liner-less label L according to the printing information entered by the operator.

When the printing operation is suspended (e.g., in a stand-by state), the free end of the liner-less label L remains pulled out by a predetermined length from the paper roll RP.

On an outer circumferential surface of the platen roller 207d is formed a layer (e.g., a silicon layer) to which the adhesive surface of the liner-less label L does not substantially adhere.

FIG. 3 is a block diagram showing a hardware configuration arranged within the body housing 20 of the printing device 2.

As shown in FIG. 3, the label printer 1 includes a CPU (Central Processing Unit) 201, a ROM (Read Only Memory) 202, a RAM (Random Access Memory) 203, a non-volatile memory 204, an input unit 205, an operation display unit 206, a first print unit 207, a second print unit 208, a timer unit 209, an environment detecting unit 210, a wireless communication interface 211 and a wired communication interface 212, which are connected through a bus line BL. The label printer 1 also includes a power supply unit 213 for supplying electric power required in operating the respective components of the label printer 1.

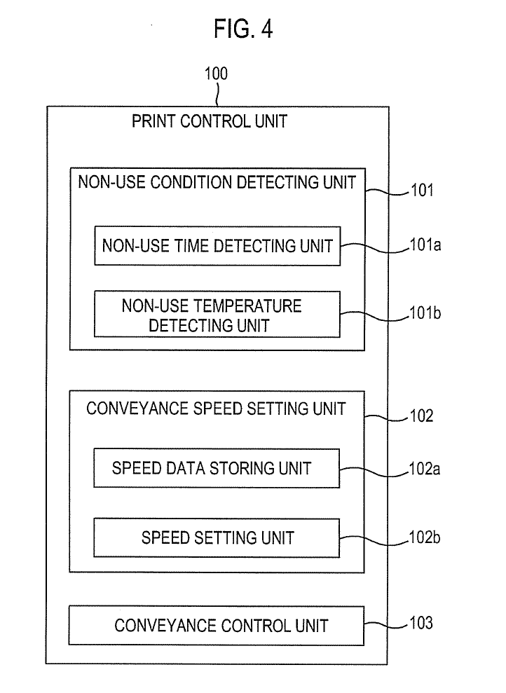

The CPU 201 serves to transfer the programs stored in the ROM 202 to the RAM 203 and execute the programs such that the CPU 201 functions as a print control unit 100 (see FIG. 4) to be described later and controls the operations of the label printer 1.

The ROM 202 stores programs and data used in executing the programs. The RAM 203 temporarily stores data generated and processed during the operation. The non-volatile memory 204 stores printing data received from an external device (not shown) such as a store server.

The input unit 205 includes the keyboard 23 as described above and a keyboard controller for performing the input processing of key operations, e.g., input made by the push buttons of the keyboard 23.

The operation display unit 206 includes the display 21 as described above and a display controller for performing the display processing of the information to be displayed on the display 21. The operation display unit 206 further includes the touch panel 22 as described above and a touch panel controller for performing the input processing of touch operations on the touch panel 22.

The first print unit 207 includes the holding shaft 207c, the thermal head 207e configured to print information on the liner-less label L using heat generated by a heating member (not shown), a head driver configured to control the heat generated by the heating member of the thermal head 207e, a motor configured to rotationally drive the platen roller 207d, and a motor driver configured to control the rotation of the motor. The first print unit 207 further includes a cutter mechanism (not shown) to cut the liner-less label L printed with information at a specified position in the vicinity of the label dispensing outlet 207b.

The second print unit 208 may have the same hardware configuration as that of the first print unit 207 and includes a holding shaft, a thermal head 208e, a head driver, a motor, a motor driver and a cutter mechanism (not shown).

The timer unit 209 counts non-use time indicating the period of time from the end of a print operation to the beginning of the next print operation. During the non-use time, the liner-less label L is not conveyed. In the present embodiment, each time a printing job is completed, a non-use time detecting unit 101a (see FIG. 4) instructs the timer unit 209 to start counting the non-use time during which the printing operation is suspended. The data indicative of the counted non-use time (hereinafter referred to as “non-use time information”) are output to the non-use time detecting unit 101a.

The environment detecting unit 210 includes a temperature sensor that detects an ambient temperature around the label printer 1 (hereinafter referred to as “non-use temperature”) and a sensor controller that performs the input processing of the data indicative of the non-use temperature detected by the temperature sensor (hereinafter referred to as “non-use temperature information”). The environment detecting unit 210 detects the non-use temperature information periodically and outputs the detected information to a non-use temperature detecting unit 101b (see FIG. 4) to be described later.

The wireless communication interface 211 is a communication interface that performs communication with an external device (not shown) such as a store server according to a predetermined wireless communication standard. The wireless communication interface 211 may be a wireless LAN (Local Area Network) interface device. The wired communication interface 212 is a communication interface that performs communication with the external device according to a predetermined wired communication standard. The wired communication interface 212 may be a USB (Universal Serial Bus) device.

The power supply unit 213 converts an electric power supplied from an external power source (not shown) such as a commercial power source to an electric power required in respective load parts of the label printer 1 such as a motor, and then supplies the converted electric power to the respective load parts.

FIG. 4 is a block diagram showing a functional configuration of the print control unit 100 of the label printer 1.

As shown in FIG. 4, the print control unit 100 of the label printer 1 of the present embodiment includes a non-use condition detecting unit 101, a conveyance speed setting unit 102 and a conveyance control unit 103.

The non-use condition detecting unit 101 includes a non-use time detecting unit 101a and a non-use temperature detecting unit 101b and detects the condition of the non-use state in which the liner-less label L is not conveyed.

In one embodiment, the non-use time detecting unit 101a monitors the end time of a printing job. Upon detection of the end time of the printing job, the non-use time detecting unit 101a instructs the timer unit 209 to count a non-use time from the time when the printing job is completed, to generate non-use time information. The non-use time information acquired from the timer unit 209 is stored and updated in a predetermined non-use time storage area defined on the RAM 203. When the print control unit 100 receives a printing instruction command inputted by the operator, the non-use time detecting unit 101a outputs the non-use time information stored in the non-use time storage area at that time to the conveyance speed setting unit 102.

Further, when a printing job is completed, the non-use temperature detecting unit 101b starts obtaining non-use temperature information from the environment detecting unit 210 and stores the obtained non-use temperature information in a predetermined non-use temperature storage area defined in the RAM 203. When the print control unit 100 receives a printing instruction command input by the operator, the non-use temperature detecting unit 101b calculates an average value of the non-use temperatures obtained during the non-use time (hereinafter just referred to as “non-use time temperature information”) based on a plurality of non-use temperature information stored in the non-use temperature storage area (as of the time when the printing instruction command is inputted) and then outputs the non-use temperature information to the conveyance speed setting unit 102.

The conveyance speed setting unit 102 includes a speed data storing unit 102a and a speed setting unit 102b. The conveyance speed setting unit 102 variably sets the conveyance speed of the liner-less label L in the printing operation performed after the non-use state, based on the non-use time information and the non-use temperature information outputted by the non-use condition detecting unit 101.

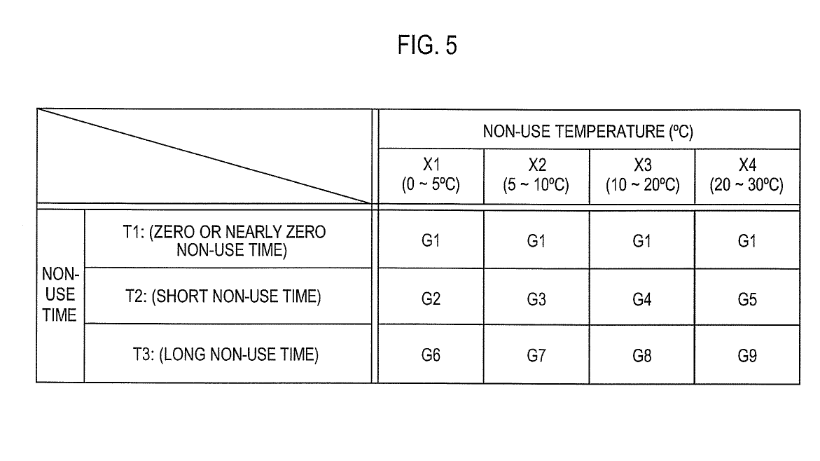

In one embodiment, the speed data storing unit 102a stores conveyance speed data of the liner-less label L (or the calculation equation for calculating the conveyance speed data) that are set differently depending on the non-use condition such as the non-use time or the non-use temperature, to avoid conveyance failure of the liner-less label L at the start time of a subsequent printing operation after the non-use state. For example, the speed data storing unit 102a holds the speed data registration table as illustrated in FIG. 5.

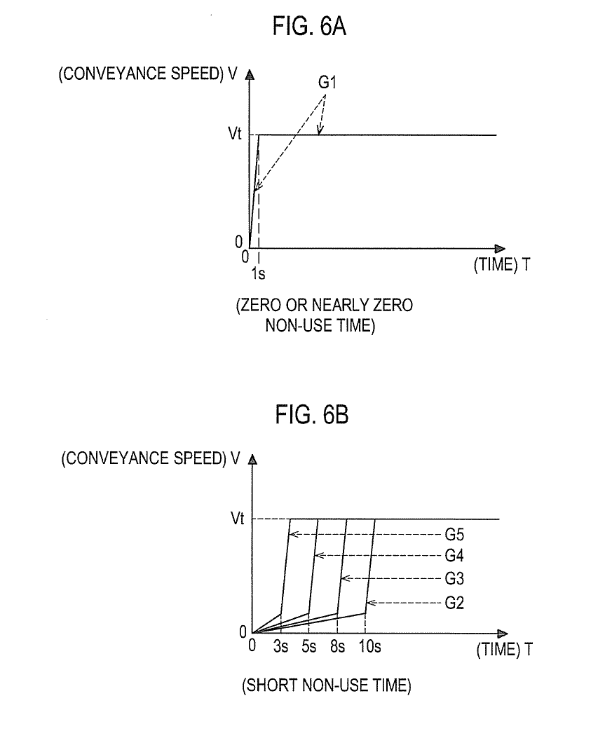

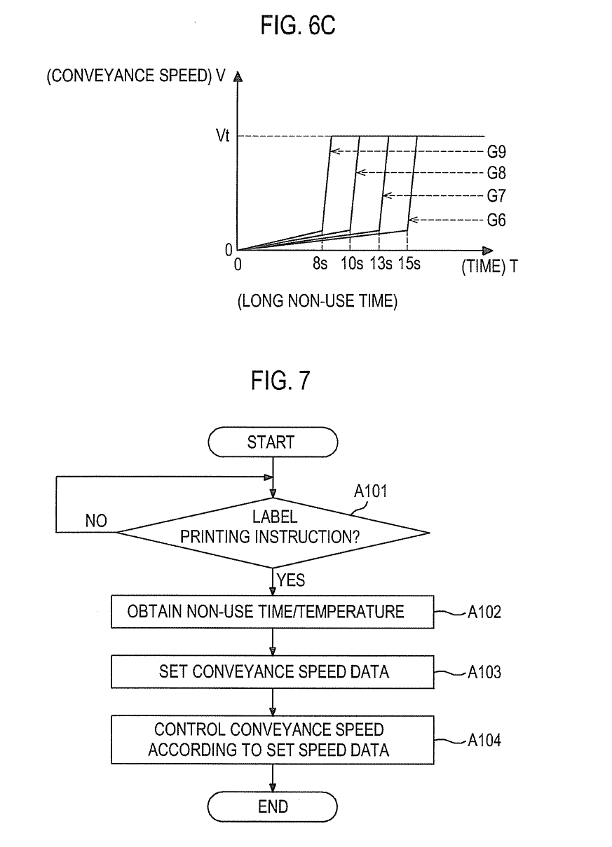

FIG. 5 is a table showing one example of the speed data registration table that stores speed data (G1 through G9) for selectively setting the conveyance speed depending on the non-use time information and the non-use temperature information acquired from the non-use condition detecting unit 101. FIGS. 6A through 6C are graphs plotting the speed data (G1 through G9) stored in the speed data registration table to show how the conveyance speed (V) may vary over the time (T).

In the example shown in FIG. 5, the conveyance speed is set based on the speed datum G1 (see FIG. 6A) if the non-use time information indicates that non-use time is zero or nearly zero (T1, e.g., ranging from 0 to 60 seconds) as in the continuous printing state (for example, in the case where the adhesiveness at the release point from the liner-less label L in the non-use state is the same as or substantially unchanged from the adhesiveness at the release point in the continuous printing state). In the case of the speed datum G1, at the start of a printing operation after a non-use state, the conveyance speed of the liner-less label L is quickly accelerated from speed “0” (static or rest state) to a target conveyance speed Vt within a short period of time (e.g., 1 second as shown in FIG. 6A) regardless of the non-use temperature (X1 through X4). After the conveyance speed reaches the target conveyance speed Vt, the conveyance speed is no longer accelerated and maintained at the target conveyance speed Vt to perform the printing operation at a desired printing speed.

The term “target conveyance speed Vt” used herein may refer to a conveyance speed preliminarily fixed depending on predetermined conditions such as the type of the liner-less label L in order to provide a suitable printing quality. Alternatively, the target conveyance speed Vt may selectively be set according to the operator's selection of a printing mode such as a high-speed printing mode or a low-speed printing mode.

In the example shown in FIG. 5, the conveyance speed is selectively set based on one of the speed data G2 through G5 (see FIG. 6B) if the non-use time information indicates that the non-use time is short (T2, e.g., below a predetermined value but above T1 or ranging from above T1 to 60 minutes) (for example, in the case where the adhesiveness at the release point of the liner-less label L in the non-use state is slightly stronger than the adhesiveness at the release point in the continuous printing state). Unlike the acceleration in the case of speed datum G1, the acceleration according to each of the speed data G2 through G5 is performed in two stages. First, during the initial conveyance time (e.g., 3 seconds, 5 seconds, 8 seconds or 10 seconds), the conveyance speed of the liner-less label L is accelerated at a first acceleration preliminarily set at a low value. After the lapse of the time period in which the liner-less label L is conveyed at the first acceleration (e.g., 3 seconds, 5 seconds, 8 seconds or 10 seconds), the conveyance speed of the liner-less label L is accelerated at a second acceleration set higher than the first acceleration until the conveyance speed reaches the target conveyance speed Vt.

In the case of speed data G2 through G5, the first acceleration may be selectively determined depending on the non-use temperature. In one embodiment, the lower the non-use temperature is, the smaller the first acceleration becomes.

In the example shown in FIG. 5, the conveyance speed is selectively set based on one of the speed data G6 through G9 (see FIG. 6C) if the non-use time is long (T3, e.g., above T2 or above 60 minutes) (for example, in the case where the adhesiveness at the release point of the liner-less label L in the non-use state is quite stronger than the adhesiveness at the release point in the continuous printing state). Similar to the case of the speed data G2 through G5, the acceleration is performed at two stages according to each of the speed data G6 through G9. However, the first acceleration according to the speed data G6 through G9 is set to be lower than the first acceleration according to the speed data G2 through G5.

In the above embodiment, although specific values are presented as examples of the non-use times T1 to T3, the present disclosure may not be limited thereto. Alternatively, different ranges of the non-use time may be selected depending on various factors such as the types of the liner-less label L and ambient conditions of the label printer 1.

The speed setting unit 102b searches corresponding speed data from the speed data storing unit 102a based on the non-use time information and the non-use temperature information, respectively, inputted from the non-use time detecting unit 101a and the non-use temperature detecting unit 101b. The corresponding speed data thus searched are used in setting the conveyance speed of the liner-less label L in the printing operation after non-use state.

The conveyance control unit 103 serves to control the conveyance speed of the liner-less label L. In one embodiment, the conveyance control unit 103 controls the rotation of the motor configured to rotate the platen roller 207d, according to the conveyance speed data set by the conveyance speed setting unit 102.

Next, description will be made on the processing operation of the label printer 1 set forth above.

FIG. 7 is a flowchart illustrating the processing sequence of the conveyance control performed by the print control unit 100. The processes shown in FIG. 7 are performed in a state in which the electric power from an external power source is supplied to the label printer 1 through the power supply unit 213 (namely, in a normal operation mode, a standby mode or a power saving mode).

As shown in FIG. 7, when an operator enters the information to be printed and inputs an instruction to print a label in Act A101, the conveyance speed setting unit 102 obtains the non-use time information and the non-use temperature information in Act A102.

In one embodiment, in Act A102, the non-use time detecting unit 101a outputs the non-use time information (that is lastly updated and stored therein at that time) to the conveyance speed setting unit 102. The non-use temperature detecting unit 101b outputs the non-use temperature information to the conveyance speed setting unit 102. Thus, the conveyance speed setting unit 102 obtains the non-use time information and the non-use temperature information.

In Act A103, the conveyance control unit 103 searches corresponding speed data from the speed data registration table using the non-use time information and the non-use temperature information obtained in Act A102 and sets the searched speed data as the conveyance speed data of the liner-less label L.

In Act A104, the conveyance control unit 103 controls the conveyance speed of the liner-less label L according to the speed data set in Act A103 by controlling the motor, which drives the platen roller 207d.

In one embodiment, in Act A104, the rotation of the motor for driving the platen roller 207d (or the platen roller 208d) is adjusted to control the conveyance speed of the liner-less label L based on the speed data set in Act A103.

During the conveyance process of Act A104, the thermal head 207e (or the thermal head 208e) is driven under the control of the print control unit 100 to print information on the printing surface of the liner-less label L based on the printing data corresponding to the label print instruction. The processing concludes after the printing operation corresponding to the label print instruction is terminated.

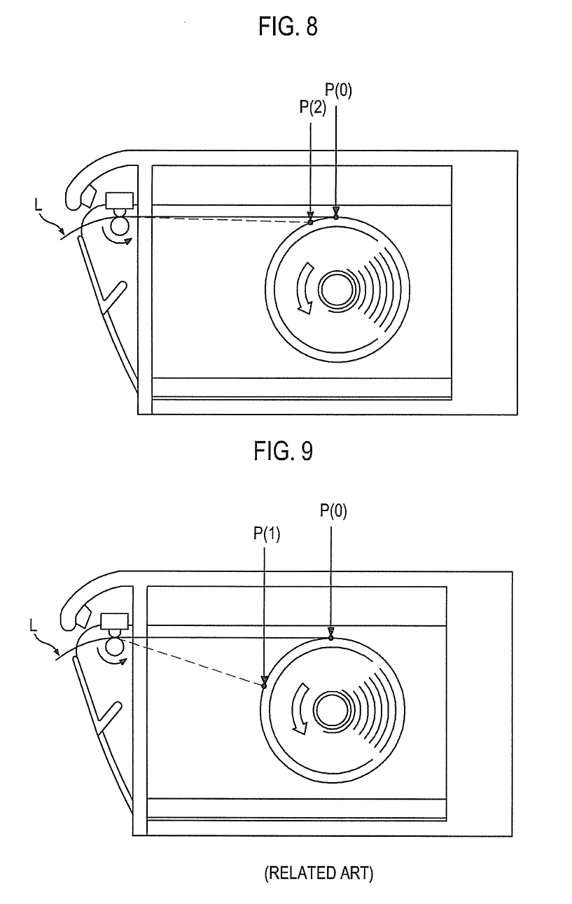

FIGS. 8 and 9 illustrate the difference between a conventional label printer and the label printer 1 of the present embodiment. FIG. 8 is a side sectional view illustrating the improvement of the label printer 1 of the present embodiment over the conventional label printer. FIG. 9 is a side sectional view illustrating the problems in the conventional label printer.

In the conventional label printer, as shown in FIG. 9, during a continuous printing state, the liner-less label L is released from the paper roll at the normal release point, namely release point P (0).

However, if the conventional label printer does not perform a printing operation for a long period of time, the adhesiveness at the normal release point P (0) in the non-use state becomes stronger than the adhesiveness at the normal release point P (0) during a continuous printing operation state. Therefore, if the conveyance of the liner-less label L is controlled in such a way that the conveyance speed of the liner-less label L is quickly accelerated from the static state to the target conveyance speed of the continuous printing operation state, namely the conveyance speed for accomplishing a desired printing speed, the liner-less label L may not be released from the paper roll at the normal release position P (0). Instead, the liner-less label L may be released from position P (1) shifted from the normal release position P (0) by a certain distance in the rotation direction of the paper roll. In that case, a specified length of the liner-less label L (e.g., the portion of the liner-less label L extending from the position P (1) to the position P (0)) may be instantaneously released from the paper roll, which loosens the released portion of the liner-less label L or rotates the paper roll slightly in the reverse direction, thereby causing conveyance failure of the liner-less label L conveyed by the platen roller. Thus, printing accuracy may deteriorate at the start of the printing operation in the conventional label printer.

The inventors of the present disclosure have found that the release force for releasing the liner-less label L from the paper roll increases in proportion to the decrease of the conveyance acceleration of the liner-less label L. In the label printer 1 of the embodiments described above, the conveyance control in the printing operation after non-use state for a specified period of time is performed to reduce the conveyance acceleration at the initial conveyance time of the liner-less label L.

In some embodiments, the conveyance speed of the liner-less label L in the printing operation after non-use state is set differently depending on the non-use condition such as the non-use time or the non-use temperature.

In the label printer 1 of the above embodiments, as shown in FIG. 8, the liner-less label L is released from the paper roll at the normal release position P (0) or released from the paper roll at the position P (2) located in the upstream of the release position P (1) of the label printer (particularly, at the position in the vicinity of the normal release position P (0)).

In other words, the label printer (printing device) of the embodiments described above is configured to control the conveyance speed of the liner-less label (printing medium) conveyed by the platen roller (conveyor) so that the initial conveyance acceleration of the liner-less label (printing medium) can be reduced in the printing operation after a non-use state, i.e., in printing operations other than continuous printing operations. Therefore, it is possible to avoid the conveyance failure of the liner-less label (printing medium) at the start of the printing operation after a non-use state and prevent a decrease in the printing accuracy after non-use state.

While some illustrative embodiments have been described above, the present disclosure may not be limited thereto.

In the embodiments described above, the non-use temperature detecting unit 101b may calculate the average value of the non-use temperatures detected during the entire non-use time, and the conveyance speed setting unit 102 determines the conveyance speed using the average value of the non-use temperatures thus calculated. Alternatively, the non-use temperature detecting unit 101b may calculate the average value of the non-use temperatures during a certain period time of the entire non-use time, and the conveyance speed setting unit 102 may determine the conveyance speed using the average value of the non-use temperatures thus calculated.

In addition, the non-use temperature detecting unit 101b may detect the non-use temperature at the end time of the previous printing job, at the initiation time of the current printing job or at a certain point in time during the non-use state, and the conveyance speed setting unit 102 may determine the conveyance speed using the non-use temperature thus detected.

In the embodiments described above, the conveyance speed is determined based on the non-use time information and the non-use temperature information to avoid the conveyance failure of the liner-less label L in the printing operation after a non-use state. Alternatively, the conveyance speed for preventing conveyance failures of liner-less labels may be determined using only one of the non-use time information and the non-use temperature information.

In addition, the environment condition information is not limited to the non-use temperature information but may include other environment condition information such as non-use humidity information. Both the non-use temperature information and the non-use humidity information may be used as the environment condition information.

In the embodiments described above, the non-use time is acquired on the premise that the electric power is supplied from an external power source to the label printer 1. Alternatively, the label printer 1 may be configured to handle the case where the label printer 1 is disconnected from an external power source.

Further, the label printer 1 may not be provided with the timer unit 209 and the non-use time detecting unit 101a. Instead, the speed data indicative of the conveyance speed may be stored in a specified storage unit (such as a non-volatile memory 204 capable of storing contents even in the event of power interruption), by which the conveyance acceleration of the liner-less label L is controlled to be lower at the printing initiation time after power restoration and accelerated to the target conveyance speed for accomplishing a desired printing speed after a predetermined time lapse from the printing initiation time. When the electric power is restored, the conveyance of the liner-less label L may be controlled based on the speed data stored in the storage unit.

In the embodiments described above, the label printer 1 prints information on the liner-less label L using the paper roll RP produced by winding a liner-less label without a backing sheet into a roll shape, where an adhesive surface is formed on the inner side of the paper roll and a printing surface is formed on the outer side of the paper roll. Alternatively, the label printer 1 may print information on the liner-less label L using the paper roll RP having a printing surface on the inner side and an adhesive surface on the outer side.

In the embodiments described above, the label printer 1 is a thermal label printer that prints information on the paper roll RP such as a heat-sensitive paper roll. Alternatively, the label printer 1 may be other types of label printer.

For example, the label printer 1 may be a thermal transfer type label printer that makes use of a paper roll produced by winding a liner-less label without a backing sheet, which has a front printing surface subjected to abrasion treatment and a rear adhesive layer, into a roll shape. The thermal transfer type label printer may use an ink ribbon. The heat-soluble ink coated on the ink ribbon is heated and softened by a thermal head and is transferred to the printing surface.

In the embodiments described above, the label printer 1 uses the paper roll RP produced by winding the liner-less label L having an adhesive surface and a printing surface into a roll shape. Alternatively, the label printer 1 may use a paper roll produced by winding a label with a backing sheet into a roll shape.

Various kinds of programs executed in the label printer 1 of the above-described embodiments may be incorporated in a storage unit such as a ROM. Alternatively, the programs may be provided in a computer-readable recording medium or may be provided or distributed via a network such as the Internet.

In addition, the hardware configuration and functional configuration of the label printer 1, the method of setting the conveyance speed in the conveyance speed setting unit 102 and the configuration of the speed data registration table, the winding shape of the paper roll RP and the structure and material of the liner-less label L have been described by way of example. The present disclosure may not be limited thereto.

As used in this application, entities for executing the actions can refer to a computer-related entity, either hardware, a combination of hardware and software, software, or software in execution. For example, an entity for executing an action can be, but is not limited to, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatus.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS(Operating System) or the like in the apparatus.

While certain embodiments have been described above, these embodiments have been presented by way of example only, and are not intended to limit the scope of the inventions. Indeed, the novel label printer and the novel method described herein may be embodied in a variety of other forms. Furthermore, various omissions, substitutions and changes in the form of the printer and the method described herein may be made without departing from the sprit of the inventions. The accompanying claims and their equivalents are intended to cover such forms or modifications as would fall within the scope and sprit of the inventions.

What is claimed is:

1. A printer, comprising:
a holder configured to hold a printing medium wound in a roll, the printing medium having an adhesive surface and a printing surface;
a conveyor configured to release a free end of the printing medium from the roll held by the holder to convey the printing medium;
a print head configured to print information on the printing surface of the printing medium when the printing medium is conveyed by the conveyor; and
a conveyance controller configured to control the conveyance speed of the printing medium conveyed by the conveyor such that the printing medium is conveyed at a first acceleration from rest for a predetermined period of time and then a second acceleration to reach a target conveyance speed, wherein the first acceleration is less than the second acceleration.

2. The printer of claim 1, further comprising:
a detector configured to detect a condition of a non-use state in which the printing medium is at rest; and
a conveyance speed setting unit configured to variably set the conveyance speed of the printing medium based on the condition detected by the detector,
wherein the conveyance controller controls the conveyance speed of the printing medium according to the conveyance speed set by the conveyance speed setting unit.

3. The printer of claim 2, wherein the conveyance controller increases the conveyance speed of the printing medium at the second acceleration after the predetermined period of time until the conveyance speed of the printing medium reaches the target conveyance speed.

4. The printer of claim 2, wherein the detector detects a non-use time during which the printing medium is not conveyed, and the conveyance speed setting unit sets the conveyance speed according to the non-use time detected by the detector.

5. The printer of claim 2, wherein the detector detects at least one of a non-use temperature and a non-use humidity of the printer in the non-use state, and the conveyance speed setting unit variably sets the conveyance speed according to at least one of the non-use temperature and the non-use humidity detected by the detector.

6. A method for driving a printer which prints information on a printing medium wound in a roll, comprising:
receiving an instruction to print information on the printing medium;
determining a first acceleration and a second acceleration at which the printing medium is conveyed in response to the instruction;
conveying the printing medium at the first acceleration from rest; and
conveying the printing medium at the second acceleration.

7. The method of claim 6, wherein the printing medium is conveyed at the first acceleration and then at the second acceleration.

8. The method of claim 6, wherein the first acceleration is less than the second acceleration.

9. The method of claim 6, further comprising:
monitoring one or more conditions of the printer when the printing medium is at rest, wherein the one or more conditions comprises at least one of a time period, a temperature, and a humidity of the printer in the rest state.

10. The method of claim 9, wherein the printing medium is conveyed at the first acceleration for a predetermined time from the rest state and then at the second acceleration to reach a target conveyance speed.

11. A printer, comprising:
a holder configured to hold a liner-less label wound into a roll, the liner-less label having an adhesive surface and a printing surface;
a conveyor configured to convey the liner-less label during a printing operation;
a print head configured to print information on the printing surface of the liner-less label when the liner-less label is conveyed; and
a print control unit configured to vary the conveyance speed of the liner-less label conveyed by the conveyor based on one or more conditions of the printer in a non-use state in which the liner-less label is at rest.

12. The printer of claim 11, wherein the one or more conditions comprises at least one of a time period, a temperature, and a humidity of the printer in the non-use state.

13. The printer of claim 11, wherein the liner-less label is conveyed at a first acceleration from the non-use state and then a second acceleration, wherein the first acceleration is less than the second acceleration.

14. The printer of claim 11, wherein the print control unit comprising:
a detector configured to detect the one or more conditions of the printer in the non-use state; and
a conveyance speed setting unit configured to set the conveyance speed of the liner-less label according to the one or more conditions detected by the detector.

15. The printer of claim 11, wherein the print control unit controls the conveyance speed of the liner-less label conveyed by the conveyor such that the liner-less label is conveyed at a first acceleration for a predetermined period of time after the non-use state and then at a second acceleration to reach a target conveyance speed.

16. The printer of claim 15, wherein the first acceleration is less than the second acceleration.

17. The printer of claim 15, wherein the detector detects a time period of the printer in the non-use state during which the printing medium is at rest, and the conveyance speed setting unit sets the conveyance speed according to the time period of the printer in the non-use state.

18. The printer of claim 15, wherein the detector detects a temperature around the printer in the non-use state, and the conveyance speed setting unit sets the conveyance speed according to the detected temperature.

19. The printer of claim 15, wherein the predetermined period of time varies depending on the one or more conditions.

20. The printer of claim 15, wherein the first acceleration varies depending on the one or condition of the printer in the non-use state.
